(19) United States
(12) Patent Application Publication
(10) Pub. No.: US 2018/0199259 A1
(43) Pub. Date: Jul. 12, 2018

(54) Wi-Fi Signal Sharing Using A Smartphone Network

(71) Applicant: Tetherball Technology, LLC, Toronto (CA)

(72) Inventors: Albert Choi, San Jose, CA (US); Rajveer Tut, Oakland, CA (US); Rishi Mallik, Chino Hills, CA (US); Akshat S. Bhat, San Jose, CA (US)

(21) Appl. No.: 15/782,411

(22) Filed: Oct. 12, 2017

Related U.S. Application Data
(60) Provisional application No. 62/409,771, filed on Oct. 18, 2016.

(51) Int. Cl. H04W 40/22; H04W 4/80; H04W 72/04

(52) U.S. Cl. CPC H04W 40/22; H04W 84/12; H04W 72/04; H04W 4/80

(57) ABSTRACT

Data from an Internet source is received in a client running a specified app that allows the data to be retransmitted to another client. The another client sends a request for data, which is relayed by the Internet connected client to the source of Internet and data received from the source of Internet is relayed to the another client. This allows the range of an Internet source that is transmitting wirelessly to be extended through a daisychain operation. In one embodiment, each client receives data over one connection and retransmits the data over another connection, where the connections can be Wi-Fi direct and Bluetooth.

This application claims priority from provisional application No. 62/409,771, filed Oct. 18, 2016, the entire contents of which are herewith incorporated by reference.

### BACKGROUND

Access to the Internet has been called a human right by technology leaders in recent months. The effects of the Internet are everywhere. Billions of people now have access to more information than the best scientists and academics just a few decades ago. In developed economies, consumers are primarily concerned with the quality, speed and price of their connections. In the US, for example, there are multiple ways to access the Internet—including underground or strung lines/cables, cellular service, Wi-Fi, and satellite. With so much broadband access available, consumers are free to utilize software and apps from countless providers. Streaming a live game, posting a photo on a social network or downloading a movie are popular occurrences despite the massive quantities of data involved in these transmissions.

Many modern product and service companies are increasingly reliant on mobile connectivity for the acquisition of their customers. Without a strong signal, the communication literally drops off and leads to lost revenue for the company and frustration for the prospective customer. For example, Uber™ is critically dependent on mobile device connectivity. Through the use of the Uber app, the Uber driver is connected to the customer or rider. This connection needs to be strong and robust enough to allow for the consummation of the transaction and the resulting revenue to Uber. If the signal drops before the rider finishes with the Uber driver, the revenue from the rider is put at risk.

Facebook and Google are also pursuing mobile device connectivity. Their revenue model focuses on vast quantities of users and the ad revenue they generate while using the internet. Lack of internet connectivity means these companies lose ad revenue from those who cannot access the internet.

Although the growth of Internet access has increased, there are still billions of people without reliable Internet connections. This scenario is especially relevant in emerging markets with limited and overstressed infrastructure such as cell towers, routers and servers. These emerging markets—including places like India and China—contain vast numbers of users and potential customers. Without clear and uninterrupted connectivity, transactions via mobile devices become complex and problematic at best and impossible at worst. Technology companies such as Facebook, Google and Uber are betting on the dominance of mobile Internet access in emerging markets. In fact, hundreds of millions of people today in these places have only accessed the Internet through a smartphone and not a personal computer.

There is also the broader relationship between the customer and the company via its technology offering. If a company can assist the customer/user with his or her Internet connection, that company provides a high level of utility. This connectivity allows for the continued use of apps, which immediately results in better usage statistics for the companies and increased revenue through advertising.

If a user's mobile signal strength is strong, the user can go online through the use of technology owned by the current applicant Tetherball technology and find a better (faster, less expensive or both) connection; and/or monetize the user's connection by sharing with others. That technology is described in our copending application Ser. No. 14/754,624, filed Jun. 29, 2015; and Ser. No. 15/629,501, filed Jun. 21, 2017.

This technology may be less effective, however, when a user does not have a strong enough data connection to discover or access a better signal. This makes this into a significant challenge in emerging markets such as India and China. This might also occur in venues with over-used bandwidth capability—such as shows or technology conferences.

International technology companies such as Facebook and Google are not waiting on infrastructure development to be completed by governments and local Internet Service Providers (ISPs). Instead, they are directly investing in bringing Internet access to developing countries through their own technology offerings. Given their caution of governments in emerging markets, these technology companies are trying to broadcast signals with as little infrastructure on the ground as possible.

One of the solutions for getting internet to everyone is the use of long range forms of Wi-Fi instead of landlines or cellular towers. This solution involves “beaming” down a radio signal using satellites, drones, winged crafts or balloons in the sky. This allows providing a particular base station with connectivity. Essentially, this ground station becomes an “internet café” where there is connectivity via a remotely-received Wi-Fi signal.

A drawback from this approach is that people have to go to an area very close to the base station to get connectivity. The range of the Wi-Fi signal provided by these base stations is limited to between 100-1000 meters. The area of connectivity, therefore, is only a tiny portion of a large nation.

Moreover, each satellite, drone, winged craft or balloon is a significant capital investment. The base stations are also expensive and susceptible to regulations.

### SUMMARY

The present application describes a system for sharing a data connection directly from client to client.

A mobile device, is described. The mobile device has a processor, a data communicating device, and a user interface, operating using the processor to communicate data. The processor runs an application that causes the mobile device to receive data over the data communicating device from a first external mobile device which is also running said application, by requesting data using the application from the first external mobile device. Data is transmitted to transmit data to a second external mobile device which is also running the application and has requested data from the mobile device.

### BRIEF DESCRIPTION OF THE DRAWINGS

In the Drawings:

FIG. 1 shows a functional diagram;

FIG. 2 shows a diagram of communicating from client to client;

FIG. 3 shows a flowchart of operation; and

FIG. 4 shows a chart of operation

### DETAILED DESCRIPTION

Technology companies are looking for a cheap and easy way to propagate a Wi-Fi signal away from a base station which is receiving internet from a source, and out to the directly adjacent areas. According to an embodiment, this is done by transmitting the data from client to client. Each citizen or inhabitant with a smartphone can effectively become a link in a mesh or grid network.

This finds use in areas which are not wired for Internet access, such as undeveloped areas. This also can be used, however, in times of natural disasters, such as earthquakes, fires and hurricanes, when the basic backbone of Internet service might not be working properly.

Embodiments control leveraging an Internet connection without actually being in the physical range of the primary Wi-Fi router or base station. This is done by using the disclosed solution that effectively uses clients, i.e., personal devices such as smartphones, as Wi-Fi extenders.

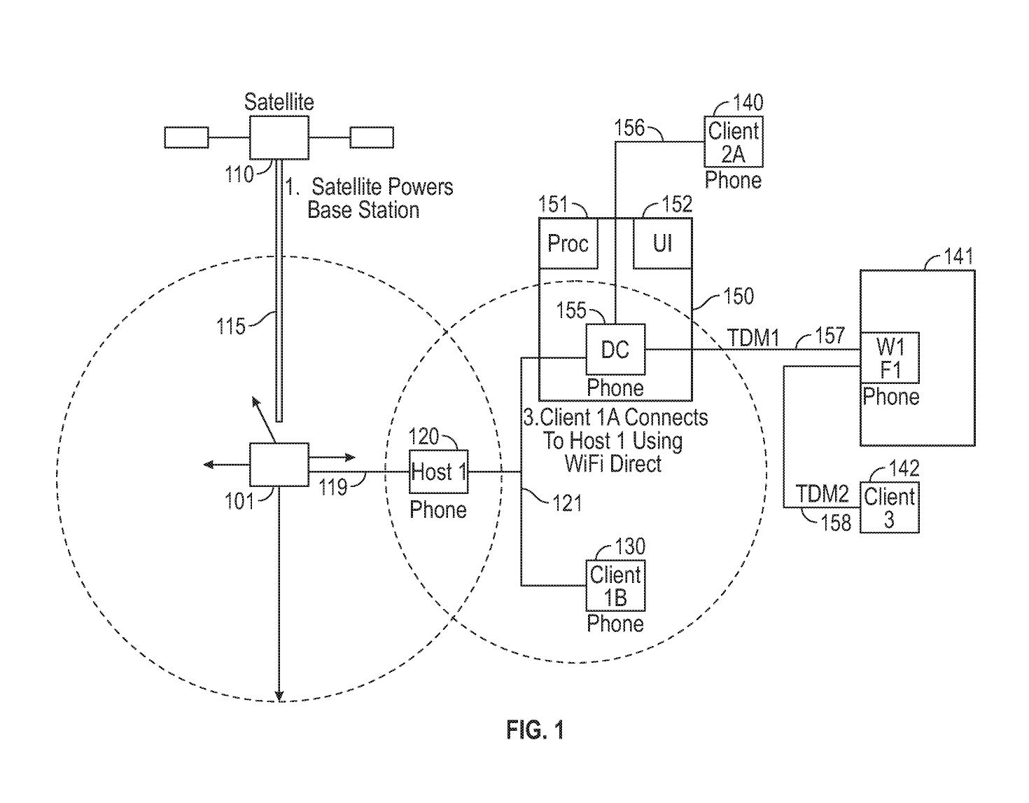

An embodiment which shows the acquisition and sharing of data is shown in block diagram form in FIG. 1. In FIG. 1, a base station 100 receives Internet from an Internet source, here a satellite 110 which provides data 115 to the base station 100. The base station 100 receives that data and using an omnidirectional antenna 101 transmits the data in all directions. The omnidirectional antenna has a range whose outer circumference is shown by the circle 103. Therefore, any client within the circle 103 can receive data directly from the base station 100.

The present invention describes programming that is executed on a client, e.g. a smart phone or tablet or other clients as described herein, to form a relay of the data received over the data path 119.

Using the “Tetherball” relay, the first client 120 is able to maintain the Wi-Fi connection to the base station while allowing bursts or packets or data to be simultaneously sent to a second client using a direct communication path that communicates directly from one client to another client. The first client 120 is located within the circle of reception 103. This first client 120 receives the information directly from the base station. The first client 120 also becomes a host by retransmitting the data to form a second circle of transmission centered around the first client. Other clients 130, 150 that are within the second circle receive the data that is retransmitted by the first client.

A mobile device 150, is described as the client which also becomes a host for other clients. The mobile device 150 has a processor 151, a data communicating device 155, and a user interface 152, operating using the processor to receive data 121 from the first client 120, and communicate that data as 156 to client 140 and as data 157 to client 141.

The processor runs an application that causes the mobile device 150 to receive data 121 over the data communicating device from the first external mobile device 120 which is also running said application, by requesting data using the application from the first external mobile device. Data is transmitted to transmit data to the second external mobile device which is also running the application and has requested data from the mobile device.

In a similar way, the clients 130 and 150 can become hosts and re-transmit the data as described herein.

In one embodiment, the direct communication path is Wi-Fi Direct. Wi-Fi Direct is a capability built into the antennae and chipset level on many new smartphones. It was designed to allow for limited marketing communications at stores and in other environments.

Another direct communication path may use AirDrop by Apple™.

Yet another communication path can use Near Field Communication (NFC).

In one embodiment, the hosts are sending out bursts or packets of data to the clients. The second user can receive the data on their smartphone or other client. The packets are not sent as one continuous stream of data, so the packets are stitched together to form a workable bundle or file. According to an embodiment, this is done in the background by the processing unit in the client that receives the data. The disclosed operation does this in the background. This provides seamless data transmission for the second user, through the first user, without the second user having to do any extra steps.

In one embodiment, host devices can broadcast a Wi-Fi signal that is backwards compatible with devices without Wi-Fi direct to increase reach.

The second client 150 may also further connect an additional user(s) such as 140, 141 through Wi-Fi or some other wireless protocol as described herein, on their device while maintaining a connection to the first user who is getting the signal from the base station. In FIG. 1, the client 141 is connected via Wi-Fi to the client-acting-as-host 150. The client acting as host 150 connects to the client 140 using Bluetooth. This effectively creates a “daisy chain” of Wi-Fi connectivity. This chain allows for additional distances to be covered through the use of individual smartphone users. In essence, the users become the infrastructure.

The present system contemplates a custom Internet browser to be contained with the app. This browser is then configured to parse through and stitch together the bursts or packets transmitted via the direct communication/Wi-Fi Direct. This may be advantageous since traditional browsers and apps typically contemplate that there is going to be a constant throughput of data, and these browsers may not correctly interpret the formatting of the data and the necessity for it to be stitched together or assembled as disclosed herein.

Another embodiment uses time splitting or multiple uses of the Wi-Fi antenna without the direct communication/Wi-Fi Direct. This allows the smartphone's Wi-Fi radio to time division multiplex between sending data on one network and receiving data on another without the need of two Wi-Fi antennas or hardware. More generally, this embodiment allows any hardware to be time division multiplexed between sending data on one network and receiving data on another without the need of two pieces of hardware. The system manages this process to ensure the optimal data transmission. Again, however, this means that the clients such as 141 spend part of their time receiving data over Channel 157, and part of their time transmitting data over Channel 158.

Data sharing can be done via Bluetooth as well according to another embodiment. A Bluetooth connection occurs via two devices pairing with each other, which can be done programmatically. Upon pairing, the two devices can send data to each other. At least some Bluetooth enabled devices can also connect to multiple Bluetooth connections. Such a multiple Bluetooth enabled client, can connect to as many Bluetooth Tetherballs as desired and stream or receive parts of the desired content between those multiple devices. Bluetooth may also have the advantage that data from any connections, e.g., cellular, wifi, or other connection be shared via Bluetooth.

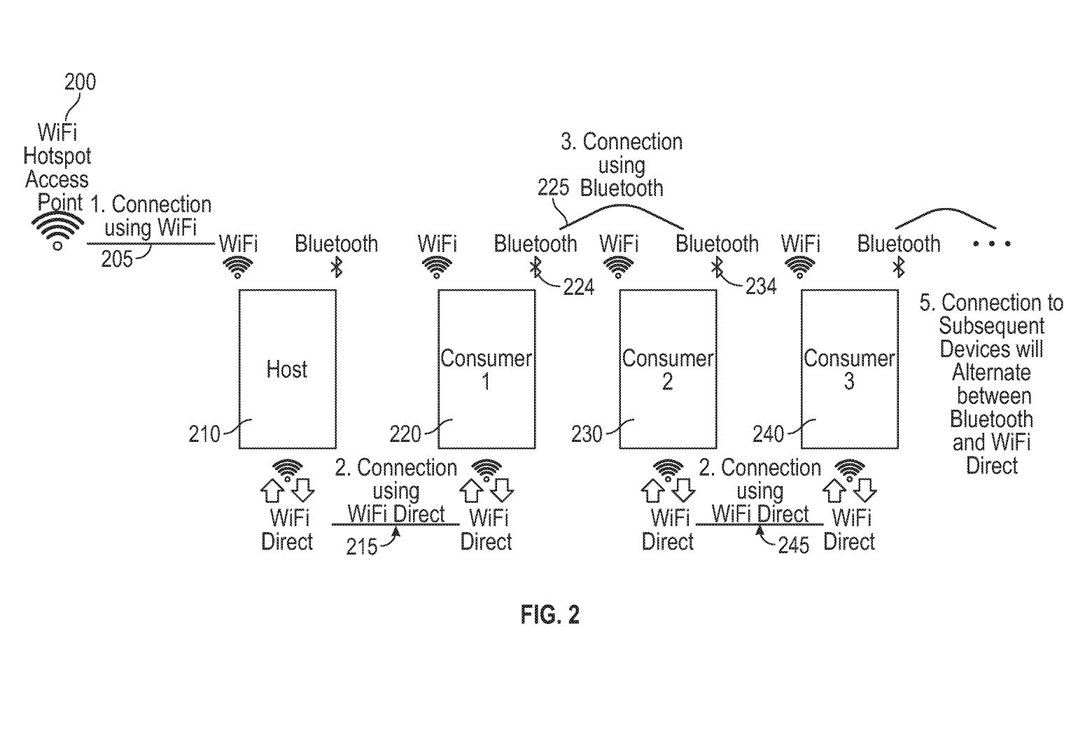

In one embodiment, the daisychain of FIG. 2 is contemplated. In this embodiment, data is received from a Wi-Fi hotspot access point 200, although as in the other embodiments, data can be received over any kind of channel. The Wi-Fi access point connects via Wi-Fi shown is 205 to the first host 210. The host 210 in turn uses Wi-Fi direct 215 to connect to the Wi-Fi direct connection on a first consumer's device shown as 220. The consumer's device 220 connects to a second device 230 via a Bluetooth connection 225 that connects from the Bluetooth capability 224 in the device 220 to the Bluetooth capability 234 in the device 230. The device 230 also transmits to another device 240 via the Wi-Fi direct connection 245. The device 240 connects to subsequent devices.

The connection in this embodiment alternates between Bluetooth and Wi-Fi direct. This extends usage of the Wi-Fi hotspot in this way. In operation, the host 210 connects to the Wi-Fi hotspot by wifi. The host 210 establishes a connection with the consumer number 1 shown as 220 using Wi-Fi direct using the same Wi-Fi antenna and chipset as in the receiving of the data via Wi-Fi. Then, consumer 2 230 connects to consumer 1 220 through a Bluetooth connection. In order to share the connection beyond one degree, the devices alternate receiving data over one wireless connection, and transmitting data over a different wireless connection. In the embodiment, the device 220 receives its data via Wi-Fi direct, and transmits its data to the device 230 via Bluetooth, because the Wi-Fi direct is already in use on the device 224 receiving data. Connection to subsequent devices alternates between Bluetooth and Wi-Fi direct.

The app that is running within the different client/phones detects whether the device is receiving data via Bluetooth or Wi-Fi direct, and automatically sends the data to the next device in the daisychain using the functionality that is not being used.

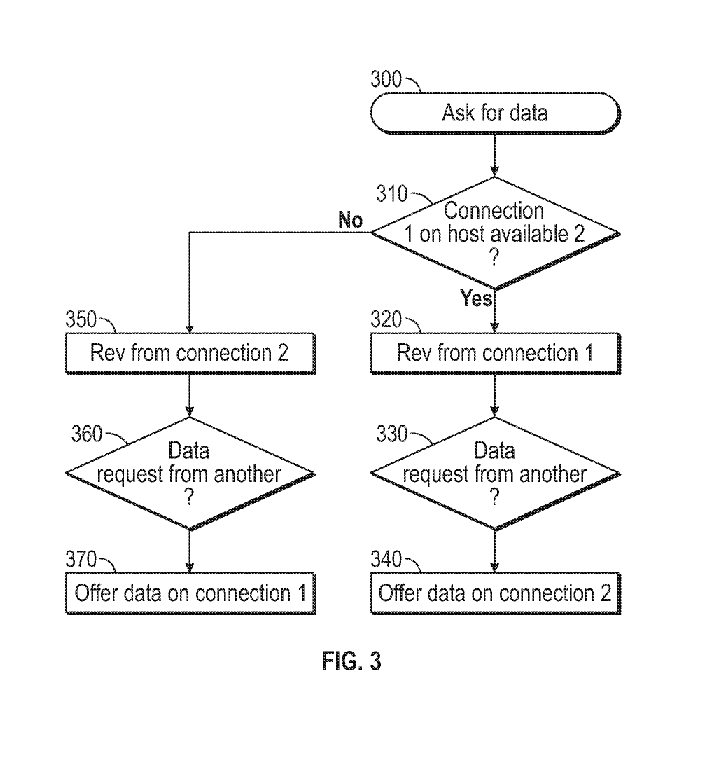

FIG. 3 illustrates a flowchart that can be carried out by any of the devices such as 220. This starts with the consumer asking for data at 300, using the tetherball app. The tetherball app will find a host that is within range, and at 310 determines if connection 1 on the host is available. Connection 1, for example in this embodiment may be Wi-Fi direct. If connection 1 is available, then at 320, data is received from connection 1. Subsequently, the device may itself be asked for data from another device over the tetherball app at 330. Responsive to such a data request, the device can offer data on connection 2, which here can be a Bluetooth connection, at 340.

If at 310, connection 2 on the host is not available, the consumer can receive data from connection 2 at 350. While receiving data from connection 2 at 350, a data request from another at 360 can be received, and data can be offered on connection 1. Here, the data is received from connection 2 which is Bluetooth, so the data is offered on connection 1 which is Wi-Fi direct. While this describes Wi-Fi direct and Bluetooth, it should be understood that any two different wireless hardware items can be used with one of the wireless hardware item receiving the data from the previous host, and the other of the wireless hardware items being used to transmit data to the next host.

In one embodiment, the data that comes from the sharing of Wi-Fi connectivity through the same Wi-Fi radio or through Bluetooth is not piped into the Network layer of the client device. By doing this, the data received only works in the app receiving it or a specific app that is authorized to receive the data. This provides an app that has a proprietary data connection that can only be used by an app authorized by the process that receives the data.

In this case the app can be ported into another app running in the hardware. For example, the Tetherball operation running on the phone can be ported into the Facebook app but would allow data received to only be utilized within the Facebook app only and not the device Network layer for general use by the client.

Another embodiment and/or extension of this software includes a hardware device that carries out the above functions, but run on a special purpose hardware, e.g., a “dongle”. This dongle can be a single purpose device without any of the overhead necessary in many of the different portable devices; as it does not require any kind of touchscreen, sensors, GPS, or other power consuming and expensive accessories that a smartphone might have. This can reduce costs and extend overall battery life). One embodiment is a simple palm sized device with cellular network connectivity equipped with a Wi-Fi module strapped on to a motherboard running Android. The system can optionally include a screen, or device that communicates to an external screen, to display relevant information about the data usage. Such a hardware device would be intended to be placed on buses, taxis, and stationary places within parks or outdoor locations where masses of people would benefit from the Wi-Fi connection.

Furthermore, in a scenario requiring widespread Wi-Fi access, e.g., more than 100 ft radius, several of these devices could be spread out in a mesh configuration. User data connections can hop from one unit to the other as they move about the space. A backend server manages and syncs the client's information across each of the hardware devices, providing an efficient way to cover large areas while maintaining the monetization of Wi-Fi access.

Another embodiment includes the modification of a device that has multiple Wi-Fi modules or a single module with capacity for simultaneous connection to multiple Wi-Fi signals. This may improve the connectivity. This embodiment would always be connected to two signals, e.g. the two “best” signals, or the “best” signal, and also the signal that the computer recognizes as showing the most likelihood of increasing data over time, and can switch to the next best signal, as the best signal fades.

The present invention also contemplates the creation of a device that either (1) extends Wi-Fi range or (2) adds on multiple Wi-Fi antennas to a smartphone. In case of the first scenario, the device would plug into the USB port of an Android device and include within it a Wi-Fi antenna and chipset for repeating Wi-Fi signals and a battery to both charge the phone and provide power to the Wi-Fi chipset. In the case of the second scenario, the device would be manufactured with the additional chipset built in. It is also contemplated that other user devices such as music player or smart watches could be utilized for their Bluetooth or Wi-Fi capabilities since the majority of these devices have both of these chipsets. The mobile device, such as a smartphone, could become the master and make the watch or other device a slave. In this way, data could be accessed through multiple antennas.

The embodiments can also be utilized by commercial partners according to another embodiment. In one embodiment, a company such as Facebook could give its users a connection or quantity of data in exchange for advertising, sponsorship, or other benefits. The sponsor company could utilize its own wireless signals or develop partnerships with the wireless carriers to provide this access. This would be effective in certain markets and at specific times. This allows, for example, a company to sponsor internet in a venue, and the users/clients can connect to a signal sponsored by the sponsor company. The company would get a lot of “eyeballs” on their products while providing a benefit to the users, all in the context of an easy-to-use app as described here.

The present invention can also be vertically integrated within an existing social networking company or other industry leader. Companies such as Facebook are almost entirely dependent on their users for content submission, maintenance, updates, viewing and downloading. This requires connectivity on both sides of the network (upload and download). Consequently, limited Internet access causes the entire business of these companies to suffer. The enhanced data connections of the embodiments can provide that internet. With more data being transmitted and more users, the value proposition is greatly enhanced.

Another aspect of the present invention is the ability to promote Internet access and connectivity in less developed nations. Without the infrastructure of more developed economies, residents in these places do not have the access they need for education, health and business. Companies such as Google and Facebook have experimented with various technologies including balloons and drones. The current invention allows wireless Internet access to expand in these places with far less infrastructure investment. It provides a low-cost mesh or peer-to-peer network where the use of bandwidth is shared and maximized in a smart and economical way.

This invention also anticipates the power of effective peer-to-peer data sharing. With the recent news headlines over government surveillance and the record keeping of large companies, many people are concerned for the safety and privacy of their data. With peer-to-peer, it is possible for users to share data without sending it through the “cloud.” This process provides an infrastructure for an “under the cloud” solution that would increase privacy, enhance flexibility and reduce network congestion. It's about sharing data when and where it's required without excess travel and transmission.

Another communication channel of yet another embodiment operates on a mobile device to connect to free/open Wi-Fi networks nearby. These could be hardwire or landline networks. The app programmatically activates the hotspot with these steps. The user's device sends a request to activate the nearby hotspot. If the hotspot were available but not currently active, a request is sent through push or SMS to request the hotspot to turn on. This request would contain the SSID and password from the consumer/user to the host in a dynamic fashion thus creating a network profile. The host's device has its hotspot turned on with the new credentials. This router is then added to a database of potentially available routers in that geographic location. The SSID is collected for nearby hosts. The present invention maintains the system to collect the password for the connection.

It is also anticipated that enhanced connectivity options could be achieved through the use of compression and encoding. The images could be encoded into binary objects for compression. The images could be converted in JPEG format for further reduction into base64 strings. The base64 strings would be compressed using run-length encoding. The compressed string would be turned into sound by encoding the string into variation through amplitude, frequency, phase modulation and other analytical measures. These would make up the variables in the following algorithm: x*Amplitude_Coefficient+y*Frequency_Coefficient+z*Phase_Coefficient; x, y, z are variables that are composed from the compressed string.

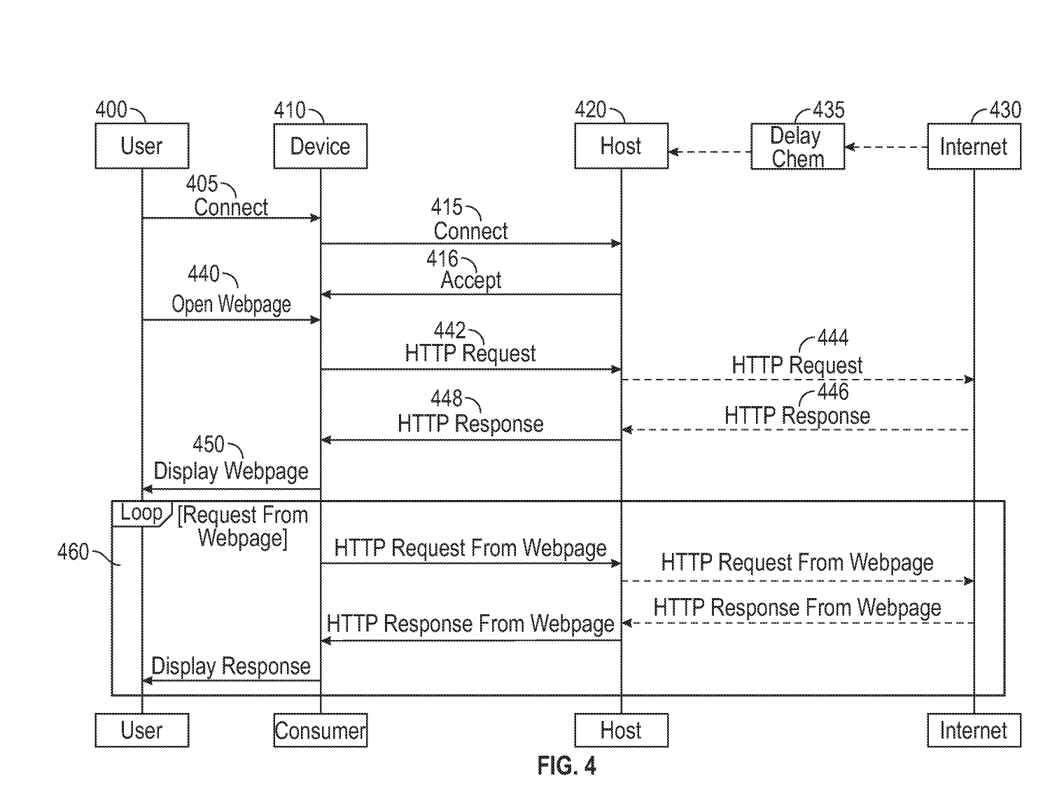

FIG. 4 illustrates a flow diagram of connecting to the Internet. Using the system of the present application. The user 400 enters commands on the user interface of the mobile device. For example, the user might first enter the command to connect on to the device 410. The device 410 uses the tetherball app contained therein to find a host 420 who is providing data provided from an Internet source 430. The Internet source 430 may itself be relayed through one or more daisychain connections shown generically as 435. The host has Internet connection which it receives, therefore, through this daisychained connection. Responsive to the user requesting a connection, the device then requests the connection at 415 from the host. The host can accept this connection at 416, when the tetherball app in the host 420 indicates that the host 420 has data via the Internet that it can share. For example, the host 420 may be running the flowchart shown in FIG. 3 to provide data to the device 410. Once the data is accepted, the device 410 will indicate that it has a data connection.

The user can then, for example begin requesting data over the tetherball connection. At 440, the user can request opening of a webpage. This is sent to the device 410 which in turn provides an HTTP request 442 to the host 420. The host 420 receives this HDTV request into its tetherball app, and translates this into its own HTTP request 444 which it sends over the Internet and receives a response at 446. The host upon receiving the response 446 relays this as the HTTP response 448 to the device 410. This causes the device 410 to display the desired webpage 450 to the user 400. This all continues in a loop shown generically as 460 where requests from the webpage and responses are received via the daisychained connection. The user, device 410, and host 420 may all move or change their connectivity, all of which causes the tetherball app to define a different connectivity path, for example is shown in FIG. 3.

While the preferred embodiments have been shown and described, it will be understood that there is no intent to limit the invention by such disclosure, but rather, is intended to cover all modifications and alternate constructions falling within the spirit and scope of the invention.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments, which might be predictable to a person having ordinary skill in the art. For example, other operating systems could be used, other code in the same operating system, or the like.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value might be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A mobile device, comprising:
a processor;
a data communicating device; and
a user interface, operating using the processor to communicate data,
said processor running an application that controls the mobile device to receive data over the data communicating device from a first external mobile device which is also running said application, by requesting data using the application from the first external mobile device;
and the application also controlling transmitting data to a second external mobile device which is also running said application and has requested data from the mobile device.

2. The device as in claim 1, wherein the data is received and sent over the same data communicating device, at different times, via time division multiplexing the data communicating device between sending and receiving data.

3. The device as in claim 1, further comprising a second data communicating device, where the second data communicating device transmits the data to the second external mobile device which is also running said application and has requested data from the mobile device.

4. The device as in claim 3, wherein the first and second data communicating devices communicate using different transmission formats.

5. The device as in claim 4 wherein one of the data communicating devices communicate using Bluetooth and the other of the data communicating devices communicates using Wi-Fi direct.

6. The device as in claim 4, wherein the application runs on the processor to determine which of the first or second data communicating device is receiving data from the first external mobile device, and automatically causes the other of the first or second data communicating devices to transmit the data to the second external mobile device.

7. The device as in claim 3, wherein the application runs on the processor to automatically configure the first and second data communicating devices depending on which of the first and second data communicating device is transmitting data from the first external mobile device.

8. The device as in claim 1, wherein the computer application running on the processor prevents the data from being routed to specified other computer applications running on the client, and only allows the data to be routed to certain enumerated computer applications running on the client.

9. The device as in claim 4, wherein the first data communicating device in the mobile device receives the data from the first external mobile device using a first transmission format and file type,
and the second data communicating device in the mobile device transmits the data to the second external mobile device using a second transmission format and file type,
and the second external mobile device receives the data in the second transmission format and file type, and transmits the data in the first transmission format and file type to a third external mobile device.

10. A device for sharing an internet connection, comprising:
a wireless client that sends and receives data;
a first communicating device, in the wireless client, that receives internet from a source over a first wireless channel using a first wireless format,
a second communicating device that transmits the internet received from the source to a recipient over a second wireless channel using a second wireless format,
where the first communicating device and the second communicating device operate simultaneously to receive data and send data,
whereby the device operates to extend a length over which the internet from the source is transmitted.

11. The device as in claim 10, wherein the first communicating device uses Wi-Fi, and the second communicating device uses Bluetooth.

12. The device as in claim 10, wherein the device further includes a processor, running a computer application that detects which of the first communicating device and the second communicating device is receiving data, receives a request from the recipient to retransmit Internet data to the recipient, and automatically routes requested data over the part that is not receiving data from the Internet.

13. The device as in claim 12, wherein the computer application running on the processor prevents the data from being routed to specified other computer applications running on the client, and only allows the data to be routed to certain enumerated computer applications running on the client.

14. A method of data transfer in a mobile device, comprising:
a processor;
a data communicating device; and
a user interface, operating using the processor to communicate data,
on a processor in the mobile device, running an application that controls the mobile device to receive data over a data communicating device in the mobile device from a first external mobile device which is also running said application, by requesting data using the application from the first external mobile device; and
also controlling transmitting data to a second external mobile device which is also running said application and has requested data from the mobile device.

15. The method as in claim 14, further comprising time division multiplexing the data communicating device between sending and receiving data, wherein the data is received and sent over the same data communicating device, at different times.

16. The method as in claim 14, further comprising a second data communicating device, where the second data communicating device transmits the data to the second external mobile device which is also running said application and has requested data from the mobile device.

17. The method as in claim 16, wherein the first and second data communicating devices communicate using different transmission formats.

18. The method as in claim 17 wherein one of the data communicating devices communicate using Bluetooth and the other of the data communicating devices communicates using Wi-Fi direct.

19. The method as in claim 16, wherein the first data communicating device in the mobile device receives the data from the first external mobile device using a first transmission format and file type,
and the second data communicating device in the mobile device transmits the data to the second external mobile device using a second transmission format and file type,
and the second external mobile device receives the data in the second transmission format and file type, and transmits the data in the first transmission format and file type to a third external mobile device.
